(19) United States
(12) Patent Application Publication
(10) Pub. No.: US 2021/0345568 A1
(43) Pub. Date: Nov. 11, 2021

(54) Hydroponic System for Bulb Horticulture

(71) Applicant: Hamama, Inc., West Sacramento, CA (US)

(72) Inventors: Camille Elyse Richman, Sacramento, CA (US); Daniel Hayim Goodman, Sacramento, CA (US)

(21) Appl. No.: 17/134,157

(22) Filed: Dec. 24, 2020

Related U.S. Application Data
(60) Provisional application No. 63/082,460, filed on Sep. 23, 2020.
(60) Provisional application No. 63/058,601, filed on Jul. 30, 2020.
(60) Provisional application No. 62/953,419, filed on Dec. 24, 2019.

(51) Int. Cl. A01G 31/02; A01G 22/35; A01G 24/25; A01G 24/44

(52) U.S. Cl. CPC A01G 31/02; A01G 24/44; A01G 24/25; A01G 22/35

(57) ABSTRACT

A hydroponic growing system configured for growing plants from bulbs. In various embodiments including features configured for accommodating bulbs of various sizes and/or types.

### CROSS REFERENCE TO RELATED APPLICATIONS

This application claims priority and benefit of U.S. provisional patent applications:
63/082,460 filed Sep. 23, 2020;
63/058,601 filed Jul. 30, 2020; and
62/953,419 filed Dec. 24, 2019.
   The disclosures of these provisional patent applications are hereby incorporated herein by reference.

### BACKGROUND

### Field of the Invention

Various embodiments of the invention are in the fields of hydroponics and horticulture.

### Related Art

Hydroponic systems are efficient ways of growing plants. See for example, U.S. patent application Ser. Nos. 16/152,369 and 16/283,723, which describe unique systems that can be used by professional or hobby growers. While these systems have become popular for plants such as Cannabis and leafy vegetables, there is a need for systems better configured for the growing of bulbs.

In the context of this disclosure, a “bulb” is structurally a short stem with fleshy leaves or leaf bases that function as food storage organs during dormancy. As used herein the term “bulb” is meant to further include other plants that grow from underground storage organs, such as ornamental bulbous plants, tubers and corms (bulbo-tuber). Examples include: Amaryllis, Crinum, Hippeastrum, Narcissus, several other members of the amaryllis family Amaryllidaceae. This includes onion, garlic, leeks, shallots, and/or other alliums, members of the Amaryllid subfamily Allioideae, lily, tulip, and many other members of the lily family Liliaceae, and other plants or roots such as beets, fennel, carrots, celery, cabbage, ginger, turmeric, wasabi, yucca, and lettuces that can be regrown after an initial harvest, etc.

### SUMMARY

A system for growing bulbs comprises a hydroponic tray and lid configured to accommodate multiple bulb types. The combination of tray and lid provide a preferential environment for germination and growth of bulbs. For example, the tray may be configured to provide variable amounts of water to the bulb at different growth stages. The lid may support the bulb in a stable (e.g., upright) position and also serve to control the amount of light received by the bulb.

Various embodiments of the invention include a bulb growing system comprising: a semi-absorbent sheet having upper and lower sides separated by a thickness; a tray including one or more risers, the tray being configured to hold water, the risers being configured to support the semi-absorbent sheet and create a water reservoir below the semi-absorbent sheet; and a tray lid including a plurality of openings, sides of the tray being configured to support the tray lid such that a plurality of bulbs fit between the semi-absorbent sheet and the openings, wherein the openings are configured to hold the bulbs upright within an enclosure formed by the tray and tray lid.

Various embodiments of the invention include a bulb growing kit comprising: a semi-absorbent sheet having upper and lower sides separated by a thickness, each of the sheets optionally having a different thickness; a tray including one or more risers, the tray being configured to hold water, the risers being configured to support the semi-absorbent sheet and to create a water reservoir below the semi-absorbent sheet; and a first tray lid including a plurality of openings, sides of the tray being configured to support the tray lid such that a plurality of bulbs fit between the semi-absorbent sheet and the openings, wherein the openings are configured to hold the bulbs upright within an enclosure formed by the tray and the first tray lid.

Either the bulb growing system or bulb growing kit optionally include means for controlling a height of the openings above the semi-absorbent sheets. These means may include semi-absorbent sheets of different thicknesses, a spacer configured to be disposed between the tray and the tray lid, a tapered edge of the tray or tray lid, a width of the tray lid, a lid having openings at various heights, risers of varying heights, and/or the like.

### BRIEF DESCRIPTION OF THE DRAWINGS

FIG. 1 includes a cross-sectional view of a bulb growing system 100, according to various embodiments of the invention.

FIG. 2 includes a) a cross-sectional view of a first bulb growing system and b) a cross-sectional view of second bulb growing system, according to various embodiments of the invention.

FIG. 3 includes cross-sectional views of bulb growing systems, a) and b), having different lid shapes, according to various embodiments of the invention.

FIG. 4 includes a cross-sectional view of a bulb growing system having a lid of various heights, according to various embodiments of the invention.

FIG. 5 includes a) a cross-sectional view of a bulb growing system including a spacer, and b) an isometric view of a lid component of bulb growing system, according to various embodiments of the invention.

FIG. 6 includes a cross-sectional view of a bulb growing system including opening spacers, according to various embodiments of the invention.

FIG. 7 includes a front view of a lid component of a bulb growing system, according to various embodiments of the invention.

FIG. 8 includes a top view of a lid component of the bulb growing system of FIG. 7, according to various embodiments of the invention.

FIG. 9 includes a top view of a component of a bulb growing system including openings of various sizes, according to various embodiments of the invention.

FIG. 10 includes a top view of a lid component of bulb or net cup growing system having a grid structure, according to various embodiments of the invention.

FIG. 11 includes a top view of a lid component of a bulb or net cup growing system, according to various embodiments of the invention.

FIG. 12 includes a bottom isometric view of a lid component of a bulb growing system, according to various embodiments of the invention.

FIG. 13 includes a front isometric view of a bulb growing system, according to various embodiments of the invention.

FIG. 14 includes a cross-sectional view of a bulb growing system, according to various embodiments of the invention.

FIG. 15 includes a cross-sectional view of a net-cup growing system, according to various embodiments of the invention.

FIG. 16 includes a cross-sectional view of an alternate net-cup growing system, according to various embodiments of the invention.

FIG. 17 includes a cross-sectional view of an net-cup growing system, according to various embodiments of the invention.

FIG. 18 includes a cross-sectional view of a net-cup growing system including plants, according to various embodiments of the invention.

FIG. 19 includes a cross-sectional view of a net-cup growing system including plants, according to various embodiments of the invention.

FIG. 20 includes a) top isometric view of a component of a net-cup growing system, and b) cross-sectional view of an alternate net-cup growing system, according to various embodiments of the invention.

FIG. 21 includes a cross-sectional view of a bulb or net-cup growing system having lids of various sizes, according to various embodiments of the invention.

### DETAILED DESCRIPTION

Bulbs can be grown hydroponically if held in at least a semi-upright position and provided with an appropriate amount of water. In various embodiments, the bulb growing systems disclosed herein are configured to both provide one or more bulbs an appropriate amount of water while also holding them in a stable position. The bulb growing systems include a least a tray and a lid therefor.

Too much water will drown a bulb while too little water will stunt growth. Water supply to a bulb is optionally controlled using both a semi-absorbent sheet and a set of risers disposed to create a water reservoir below the semi-absorbent sheet. In early stages of growth, water is transported to roots of the bulb at least in part by the semi-absorbent sheet. At later stages of growth, developed roots have grown through the semi-absorbent sheet to the water reservoir. This configuration provides control over the amounts of water the bulb receives at different times in its growth.

In various embodiments, the bulb growing systems disclosed herein include a lid which has openings configured to help hold the bulbs upright. The lid may also be configured to help control an amount of light received by the bulb and/or to control evaporation of the water. Optionally, a position of the lid relative to the semi-absorbent sheet can be controlled so as to accommodate bulbs of various sizes.

Bulb vegetables such as scallions or leeks can be regrown after an initial harvest of the section of the plant above the bulb. This section is usually edible but can also be used for flavoring purposes without being consumed. By placing the bulb or root side in water, the shoots and/or leaves will start to regrow and yield additional harvests. Regrowing bulb vegetables can be an efficient way to produce desirable plants such as flowers or foodstuffs. Bulbous plants that can be regrown include garlic, onion, shallot, celery, lemongrass, fennel, various vegetables, or the like, or many of the other plants discussed herein.

The most common method of regrowing bulb vegetables is by placing the bulb into a cup of water with the cut leafy section above water. This leafy section will begin to grow and be ready to harvest again after a few days. This “leafy section” will refer to the section above the bulb which may or may not be leafy as in the case of fennel or less leafy and more shoot-like as is the case for green onion or scallion. This method of regrowing, though simple and the most popular has several pitfalls.

Various embodiments of the bulb growing system discussed herein solve problems found in hydroponic bulb cultivation. For example: Airflow: Completely submerging the bulb and roots can lead to problems related to air flow. Without proper airflow, the base of the plant can become waterlogged, start rotting and microbes can start growing in the water or on the plant. This can also result in a smelly or bug-ridden crop. The semi-absorbent sheet and risers are configured to assure proper airflow around bulbs. The semi-absorbent sheet optionally comprises a mesh of density for root support. Water saturation: Filling a cup with water and letting sit in it can lead to over watering and rotting of the bulb. Further, because the water is not aerated, it can become stagnant and unsanitary for growing food. It is desirable to provide different amounts of water during different growth phases of the bulb, while also minimizing labor involved in changing water and/or water levels.

As disclosed herein, solutions to these problems include a tray, semi-absorbent sheet and tray lid.

In its simplest form the tray lid is a flat piece with an array of holes through it. The tray lid may comprise plastic, polymer, cardboard, glass, metal, and/or other suitable material. The tray lid is optionally planer, although more complex geometries are disclosed herein. These geometries can include, for example, posts or tubes to support tall plants, lids with bends and turns, etc. Optionally, the bottom of a tray lid includes an embossed feature or other registration or locking method to allow it to reference and/or lock within the growing tray and not slide off the tray. In its simplest version, the lid sits on the top surface of the grow tray but it can also be nested within the inner perimeter of the tray top or sit above the tray top. The lid can be glazed or unglazed, finished or unfinished, sealed or unsealed, textured or smooth, plastic, silicone, wood or ceramic (or other water-resistant, rigid or semi-rigid food safe material). Holes within the tray lid (referred to herein as “openings”) are configured for the growing plant and/or upper part of a bulb to pass. The openings optionally hold the bulb in place and semi-upright. The openings can be round or other shapes depending on desired functionality.

The arrangement of holes, thickness of the lid, height of the lid above the base of the tray (via standoffs, lid geometry and/or the like), and how the lid references within the tray all depend on the type of bulb vegetable being grown. For example, a garlic clove standing upright may be ˜1″ tall while a chopped green onion bulb may be ˜2-3″ tall. The lid height can be adjustable or designed for the plant specifically such that it supports the openings at the proper height. Various features for adjusting the height of the tray lid are discussed herein. The height may be adjusted above the tray and/or the semi-absorbent sheet.

Planting: To plant, a user simply has to take their tray, fill it up to a fill line, place a sheet of semi-absorbent sheet (e.g., coconut fiber) inside and let the sheet soak up water. Then they place the lid on top of the tray and place bulbs through the lid openings and set them on the coconut fiber. Then they can place their tray on a shelf or countertop and let it grow. The bulbs might also be inserted from the other direction, through the bottom of the lid. The plants might be transplanted into this system either before or after having been cut already. Additional hardware can be built into or attached to the lid including but not limited to support posts for the plants, a humidity dome, lighting system, water level indicator etc.

Harvesting: The growing plants are optionally continuously harvested with knives or scissors from the tray system. Alternatively, the growing plant may be harvested using an automated system configured to cut new growth at a specific height above the tray lids. The users might get many cuttings before having to either refill the water and/or plant new base crops. The orientation of the holes can be designed to facilitate easier harvesting by the user or robotic harvester.

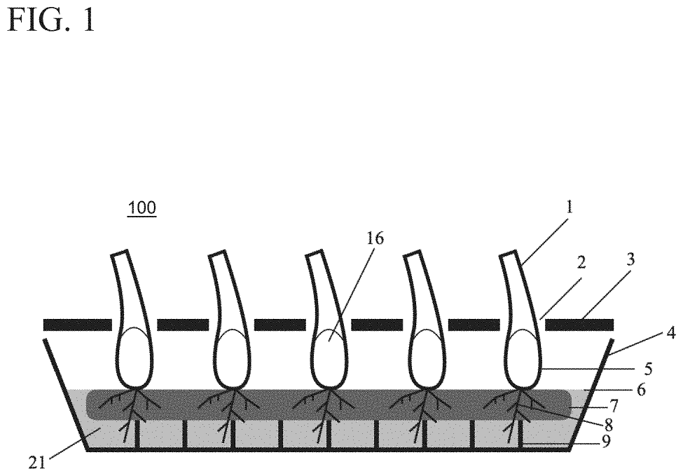

FIG. 1 includes a cross-sectional view of a bulb growing system 100, according to various embodiments of the invention. Shown are grow tray (4), tray lid (3), a semi-absorbent sheet (e.g., a coconut fiber sheet) (7) and bulbs (16). Water (21) is filled to an optional water level (6), and top surface of semi-absorbent sheet (7) is at the water level (6). The bulb portion (5) of the plant is in contact with the semi-absorbent sheet (7) and the leaf portion (1) (if grown) or top of the bulb of the plant extends through the lid opening (2) and protrudes above the tray lid (3). The bulb (16) grows existing and/or new roots (8) into the semi-absorbent sheet (7) and is watered by wicking action of the semi-absorbent sheet (7) and root (8) uptake from the reservoir of water (21) created by risers (9). Risers (9) are configured to create reservoir of water (21) below the semi-absorbent sheet (7).

Semi-absorbent sheet (7) can include any of the materials disclosed in commonly owned U.S. patent application Ser. No. 16/152,369, the disclosure of which is incorporated herein by reference.

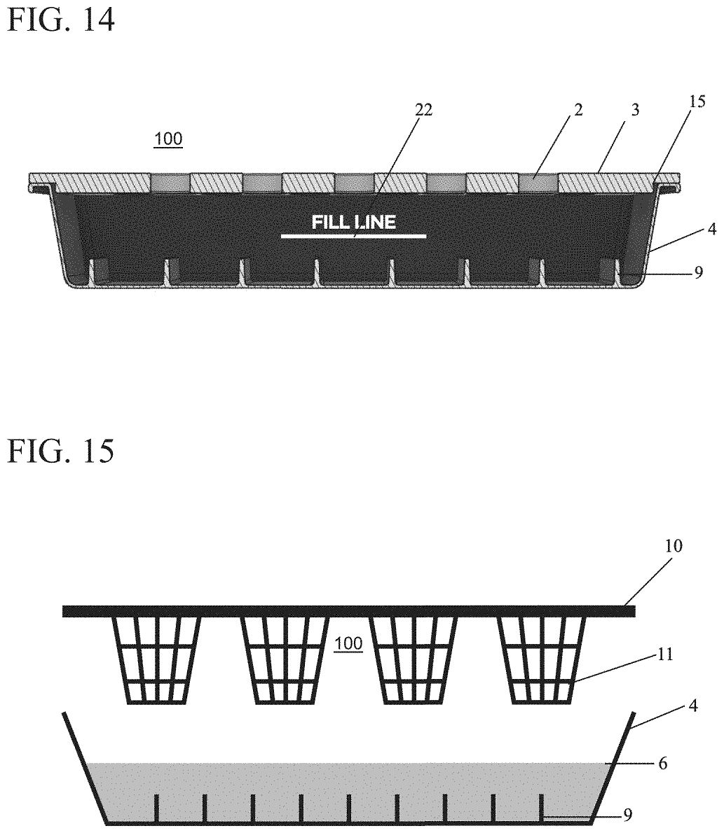

FIG. 1 is a cross sectional view of the grow tray (4) including growing bulbs disposed between the semi-absorbent sheet (7) and the bulb lid (3). The tray has a sheet of coconut fiber (previously described) placed over the risers. The water fill level is approximately at the level of the upper face of the coconut fiber sheet. Over time the water level drops as the plants use the water such that the base of the crops are no longer submerged in water. The reservoir risers ensure there is enough water for several days or weeks of the bulb vegetables' growth. The vegetable roots will start to grow into the coconut fiber and water below eventually pulling water directly from the reservoir of water below the coconut fiber sheet between the risers and leaving the base of the plant in air only. In FIG. 14, the water is represented by the light grey shaded area in the lower half of the grow tray (4). The roots in the coconut fiber differentiate into air roots (to pull oxygen from the air) and the roots in the water differentiate into water roots (to pull oxygen from the water and provide water to the plants). These root differences have been previously described and are important in maintaining the overall health of the plant. The use of the semi-absorbent sheet (7) allows this change in water supply and root exposure to take place without intervention. It occurs as the water evaporates and the roots grow. The thickness of the semi-absorbent sheet (7) is optionally selected to optimize these processes. The coconut fiber ensures good airflow to the roots and minimizes the likelihood of mold, bacteria or other microbes and pests from growing. The openings in the lid provide a support for the vegetable as it grows, keeping it upright to allow the roots to take hold and grow into the coconut fiber. The leaf portion of the plant is above the lid and can be harvested when it is ready. In some embodiments, grow tray (4) includes an overflow port configured to limit water height.

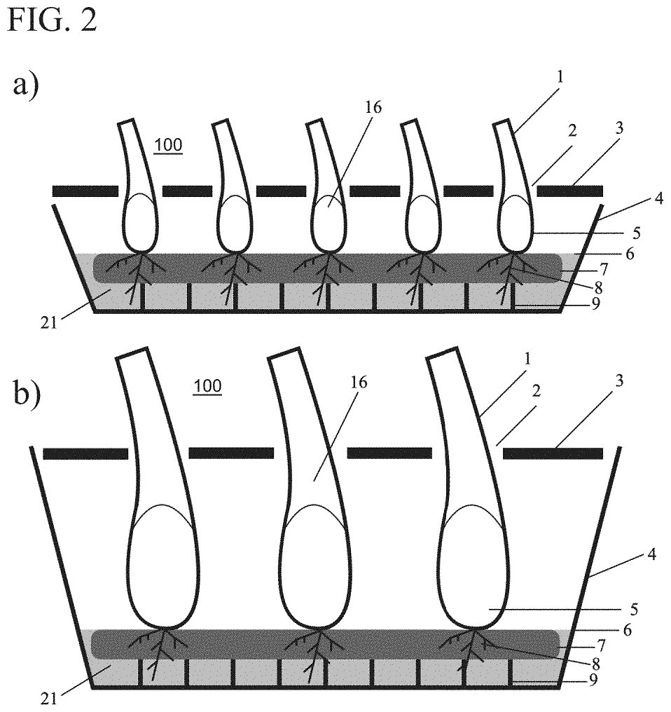

FIG. 2 includes a) a cross-sectional view of a first bulb growing system and b) a cross-sectional view of second bulb growing system, according to various embodiments of the invention. FIG. 2 shows bulbs of different sizes and quantity. A tray lid (3) can include openings for 1, 2, 3, 4 or more bulbs. The grow tray (4) of FIG. 2.(b) is made taller compared to the grow tray (4) of FIG. 2.(a) to accommodate the larger bulbs (16).

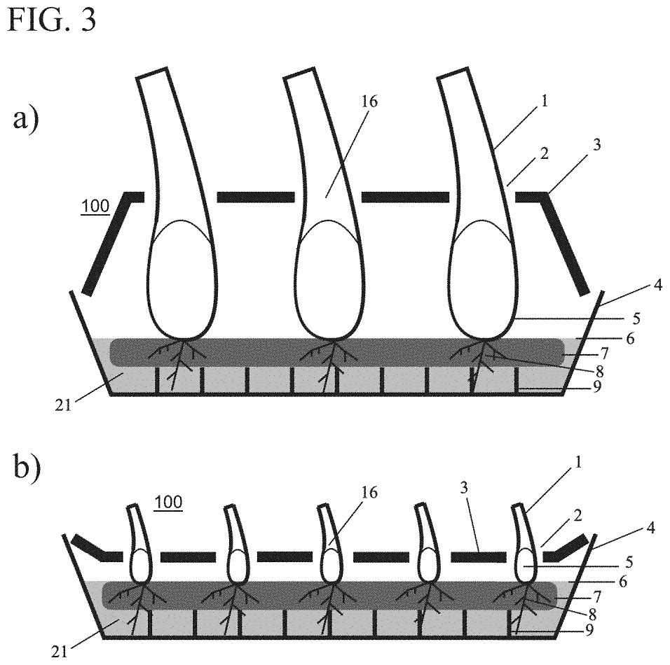

FIG. 3 includes cross-sectional views of bulb growing systems, a) and b), having different lid shapes, according to various embodiments of the invention. FIG. 3 shows the cross-sectional view of bulb growing system growing larger bulbs (16) and b) cross sectional view of bulb growing system growing smaller bulbs (16). The tray (4) portion of the system stays the same while the tray lid is configured to be more convex above the tray (4) to accommodate larger bulbs (16) or more concave to accommodate the smaller bulbs (16). This is another way to account for height differences in bulbs (16). The embodiments illustrated in FIG. 2.(b) accomplish this by modifying the grow tray (4), while the embodiments in FIG. 3.(a and b) accomplish this by modifying the tray lid (3) shape.

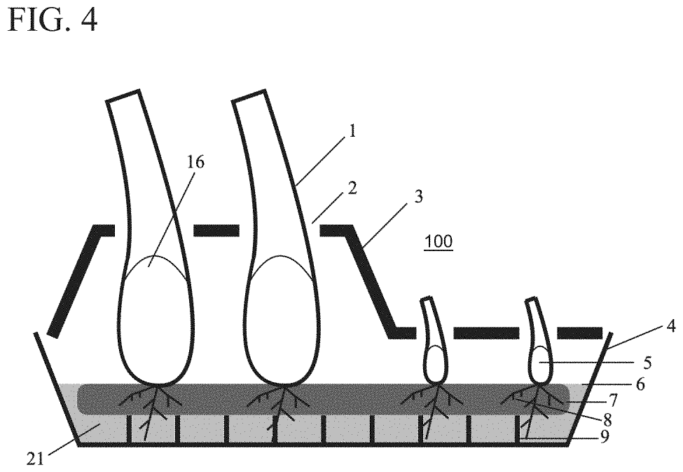

FIG. 4 includes a cross-sectional view of a bulb growing system having a lid of various heights, according to various embodiments of the invention. FIG. 4 shows a across-sectional view of bulb growing system growing larger and smaller bulbs (16) by using a multi-level “topographic” version of tray lid (3) that is taller on one side to accommodate the taller bulbs (16) and shorter on one side to accommodate the shorter bulbs (16). This version has lid openings (2) at different heights above semi-absorbent sheet (7).

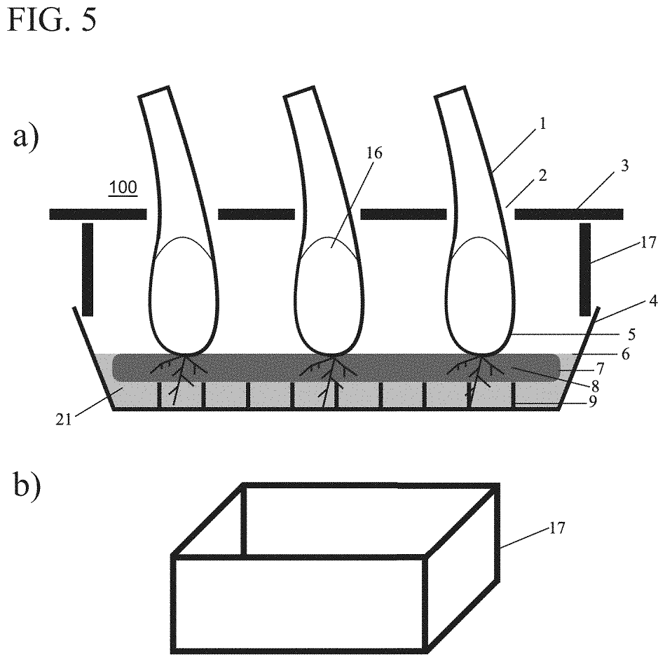

FIG. 5 includes a) a cross-sectional view of a bulb growing system including a spacer, and b) an isometric view of a lid component of bulb growing system, according to various embodiments of the invention. FIG. 5 shows a cross sectional view of bulb growing system growing larger bulbs (16) and b) front isometric view of a possible spacer (17) for a rectangular grow tray (4). Rather than make the tray lid (3) convex above the grow tray (4), a spacer (17) is utilized to lift the lid-bulb version (3) sufficiently above the grow tray (4) to accommodate the larger bulbs (16). Some embodiments comprise a kit including spacers (17) of different heights.

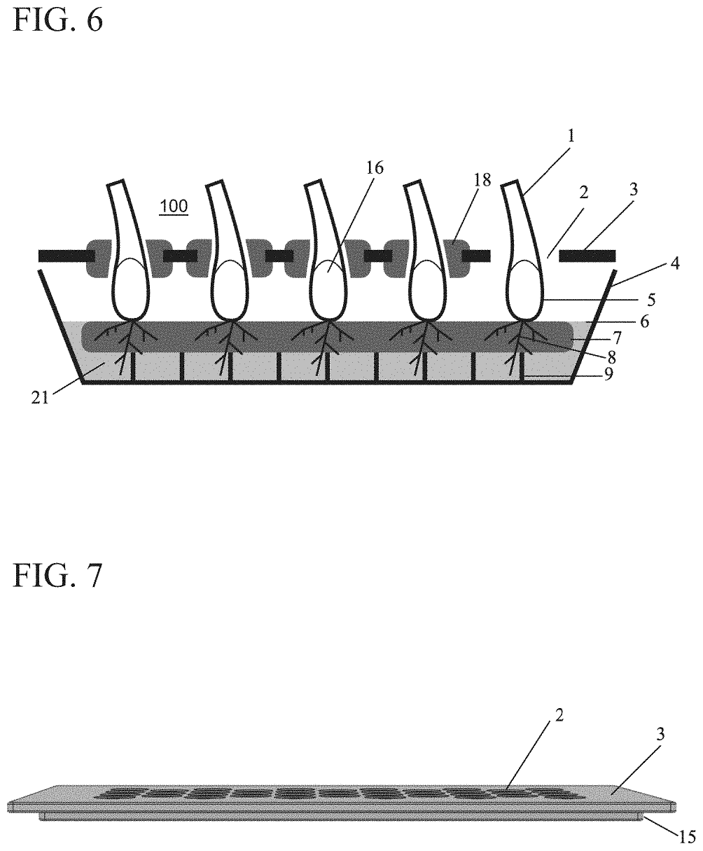

FIG. 6 includes a cross-sectional view of a bulb growing system including opening spacers, according to various embodiments of the invention. FIG. 6 shows a cross sectional view of bulb growing system utilizing grommets (18) to fill the space between the leaf portion (1) of the bulb (16) and the side of the lid openings (2). The grommets (18) could be made of compliant material or come in a range of predetermined sizes such that the lid openings (2) could be standardized (thus simplifying manufacturing) and the grommets (18) could allow for different diameters of bulbs (16) to grow. Grommets may be made of rubber, foam, plastic, polymer, any material of the semi-absorbent sheet, paper, plant extract, Styrofoam, wood, fertilizer, and/or the like. The grommets may be moisture, temperature, or microbe responsive via color change or similar and serve to alert a user to the plant's health. The grommets may have active functionality and serve to fertilize, moisturize, or desiccate depending on the needs of the plant. The plant could be inserted into the grommet through force where the plant is forced through a smaller aperture, or the grommet could be slitted, have an X pattern or similar that expands when the user pinches the grommet or the plant is inserted.

FIG. 7 includes a front view of a lid component of a bulb growing system, according to various embodiments of the invention. In FIG. 7 a front view of bulb lid (3) shows the lid openings (2) and lid ledge (15) designed to keep the bulb lid (3) nestled inside the grow tray (4 not pictured).

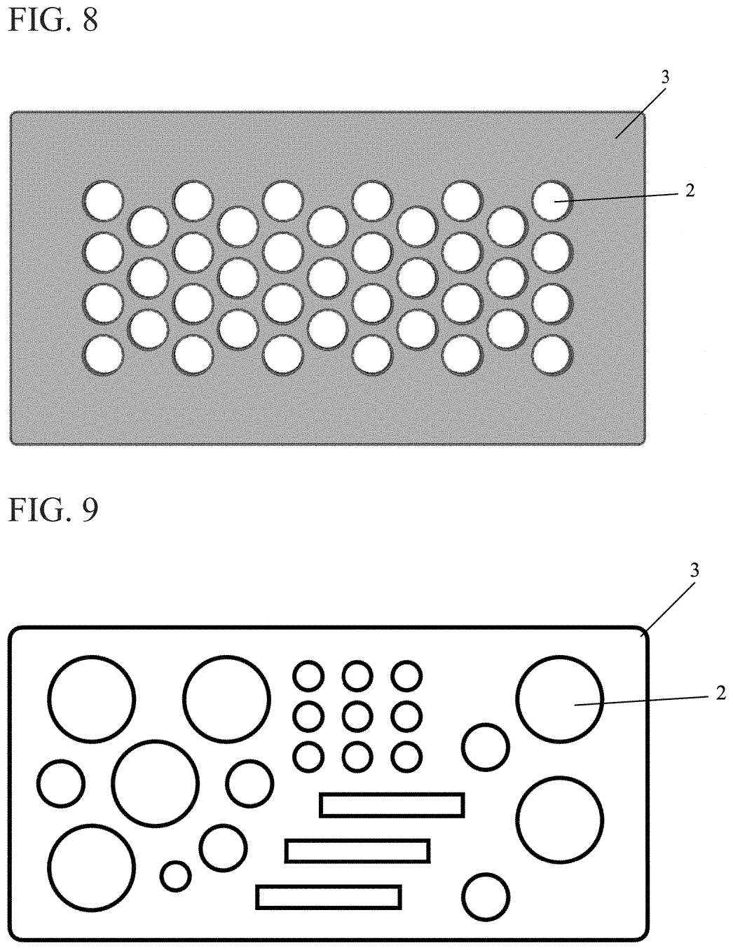

FIG. 8 includes a top view of a lid component of the bulb growing system of FIG. 7, according to various embodiments of the invention. FIG. 8 shows a top view of the bulb lid (3) of FIG. 7. Showing a possible arrangement of lid openings (2). This particular pattern was designed for a specific bulb (16) where other bulb (16) types could have different arrangements depending on the bulb (16) diameter, height, optimal planting density, ease of harvest or any number of other factors not listed.

FIG. 8 shows a top view of the lid showing a possible hole arrangement. The holes in this version are 0.75″ in diameter to accommodate larger diameter bulb scallions but they could easily be made larger diameter to accommodate thicker vegetables such as leeks. The number of holes and orientation is determined based on optimal growing space for the vegetable (factoring in leaf canopy space needs, airflow, microbe or pest mitigation, optimal planting density, and similar) and optimal space to allow a user to access and harvest the growing vegetables. The example imagery is one of many possible hole arrangements. Hole distribution doesn't need to be regular or follow a grid of some kind, the distribution can be more organic or randomized. Additionally, a single lid could contain different diameter or shaped holes for supporting multiple types of bulb plants at once as shown in FIG. 9. The hole distribution could be algorithmically determined based on the various needs of bulb or plant to be grown.

FIG. 9 includes a top view of a component of a bulb growing system including openings of various sizes, according to various embodiments of the invention. FIG. 9 shows a top view of a possible embodiment of bulb lid (3) designed to accommodate multiple lid opening (2) diameters, shapes, and arrangements. This design could be for growing multiple bulb (16) types at once for functional purposes or aesthetic. The pattern of lid openings (2) could create patterns, designs, or other aesthetic features when the bulbs (16) are just planted and/or fully grown.

FIG. 10 includes a top view of a lid component of bulb or net cup growing system having a grid structure, according to various embodiments of the invention. FIG. 10 shows a top view of a possible embodiment of tray lid (3), referred to as the lid-net cup version (10) design, where the lid is made of a mesh, grid or other similar construction designed to let varying amounts of light, air, moisture, humidity etc. through to the bulbs (16) or plants (14) below. One reason would be if the bulb (16) or plant (14) grows above ground and needs more light, vs a bulb (16) or plant (14) that needs more darkness to grow.

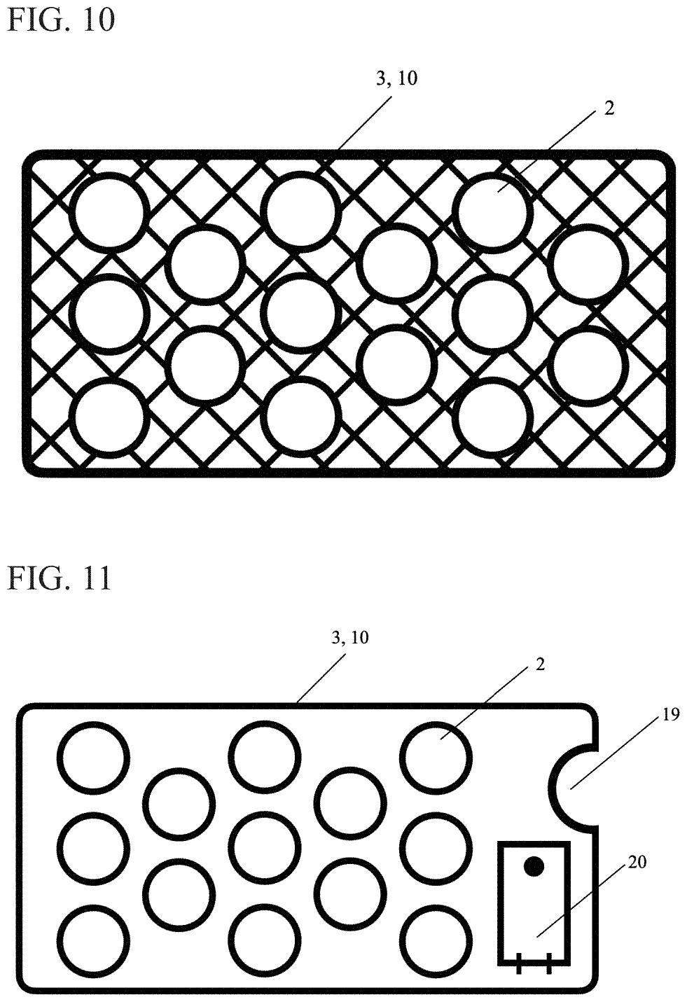

FIG. 11 includes a top view of a lid component of a bulb growing system, according to various embodiments of the invention. FIG. 11 includes a top view of an embodiment of tray lid (3). This embodiment is referred to as a “Net Cup” version (11) and includes features to provide a better user experience to the end user. A finger tab (19) is configured for lifting the lid-bulb version (3) off the grow tray (4 not pictured) and a watering hatch (20) could be opened to refill the water (21) in the grow tray (4) without the user lifting the entire tray lid (3).

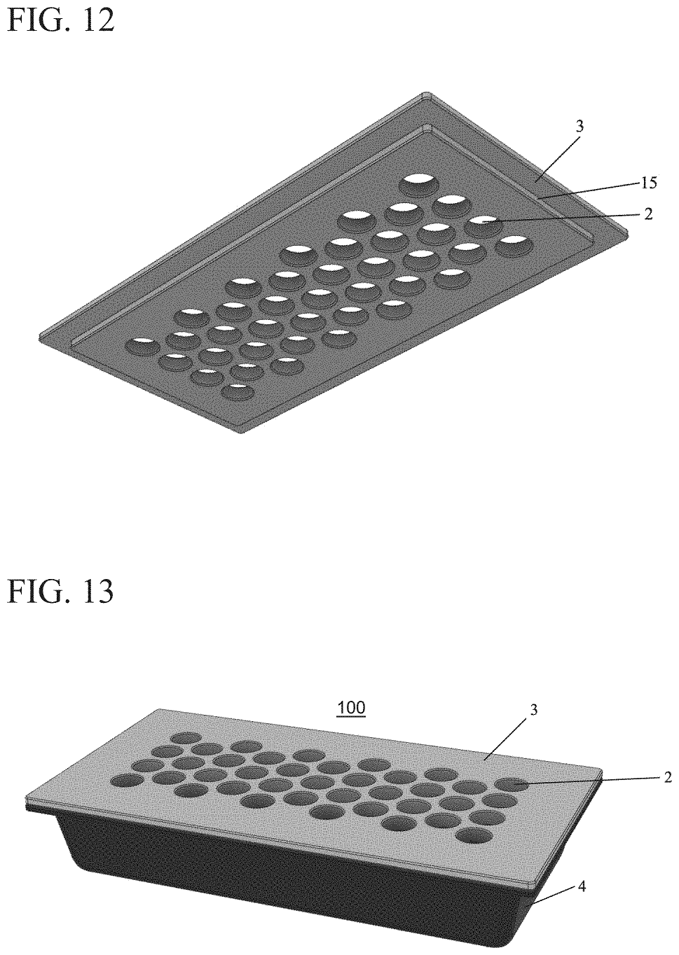

FIG. 12 includes a bottom isometric view of a lid component of a bulb growing system, according to various embodiments of the invention. FIG. 12 includes a bottom isometric view of the tray lid (3) of FIGS. 7 and 8 showing the lid ledge (15) feature.

FIG. 13 includes a front isometric view of a bulb growing system, according to various embodiments of the invention. FIG. 13 shows a view of the tray lid (3) sitting on top of a grow tray (4) made by Hamama, Inc. The lid ledge (15, not visible) prevents the tray lid (3) from sliding off the tray (4).

FIG. 14 includes a cross-sectional view of a bulb growing system, according to various embodiments of the invention. FIG. 14 shows a cross sectional view of the tray lid (3) and grow tray (4). The 8 risers (9) protruding from the base of the grow tray (4) create the water reservoir. The risers can be seen at the bottom and the lid openings (2) can be seen at the top. The optional fill line (22) is visible at the back. Embodiments of grow tray (4) can include at least 1, 2, 3, 4, 6, 8, 10 or more risers (9), or any number therebetween.

FIG. 15 includes a cross-sectional view of a net-cup growing system, according to various embodiments of the invention. FIG. 15 cross sectional view of a net cup growing system showing the lid—net cup version (10) above the grow tray (4). The risers (9) are visible at the bottom of the grow tray (4) and net cup portion of lid (11) visible on the lid—net cup version (10). This grow method could be used with semi-absorbent sheet (7) or without depending on the growing media plug (12) inserted into the net cup portion of the lid (10).

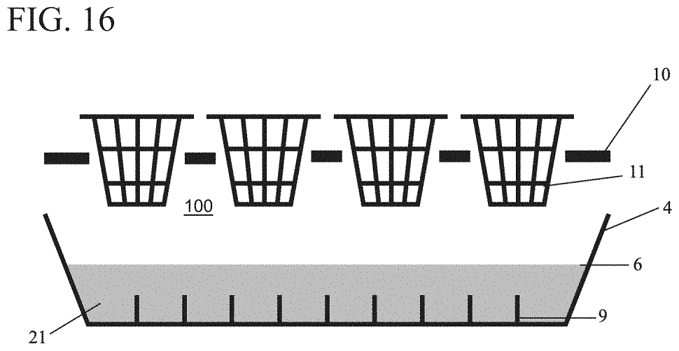

FIG. 16 includes a cross-sectional view of an alternate net-cup growing system, according to various embodiments of the invention. FIG. 16 shows a cross sectional view of a net cup growing system showing the lid—net cup version (10) above the grow tray (4). This design utilizes removable net cup portions of the lid (11) that are seen passing through the lid-net cup version (10) through lid openings (2). This way individual net cup portions of the lid (11) could be removed or different materials than the lid-net cup version (10) could be utilized depending on what is growing.

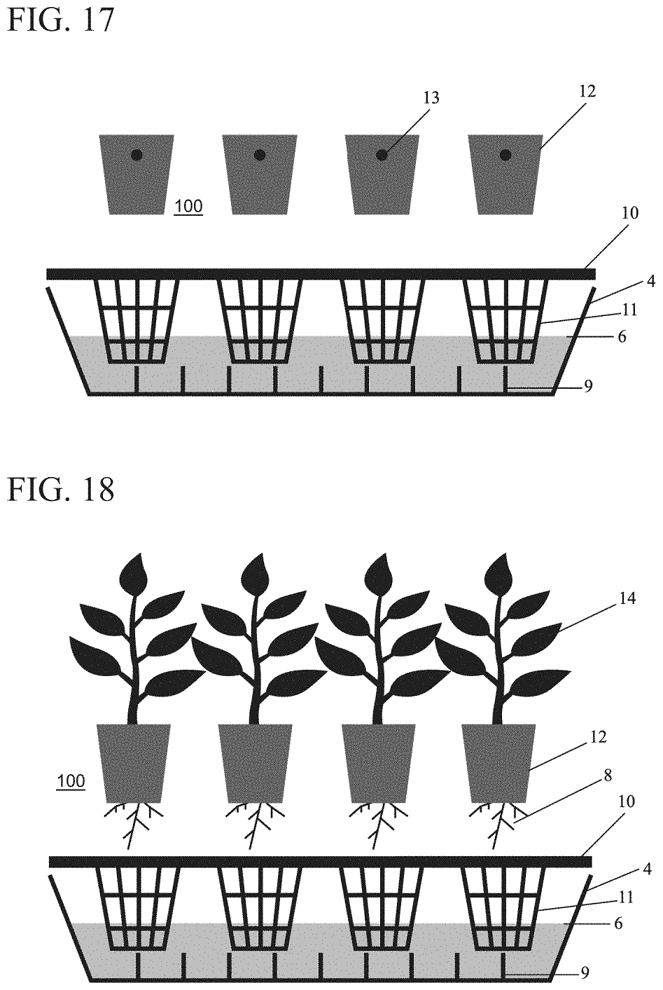

FIG. 17 includes a cross-sectional view of an alternate net-cup growing system, according to various embodiments of the invention. FIG. 17 shows a cross sectional view demonstrating grow media plugs (12) with seeds inside (13) about to be placed in the net cup growing system. The lid—net cup version (10) has been lowered into the grow tray (4) and the net cup portion of the lid (11) is partially submerged in the water).

FIG. 18 includes a cross-sectional view of a net-cup growing system including plants, according to various embodiments of the invention. FIG. 18 shows a cross sectional view demonstrating grow media plugs (12) with plants (14) about to be placed in the net cup growing system. The tray lid version (10) has been lowered into the grow tray (4) and the net cup portion (11) of the tray lid (10) is partially submerged in the water.

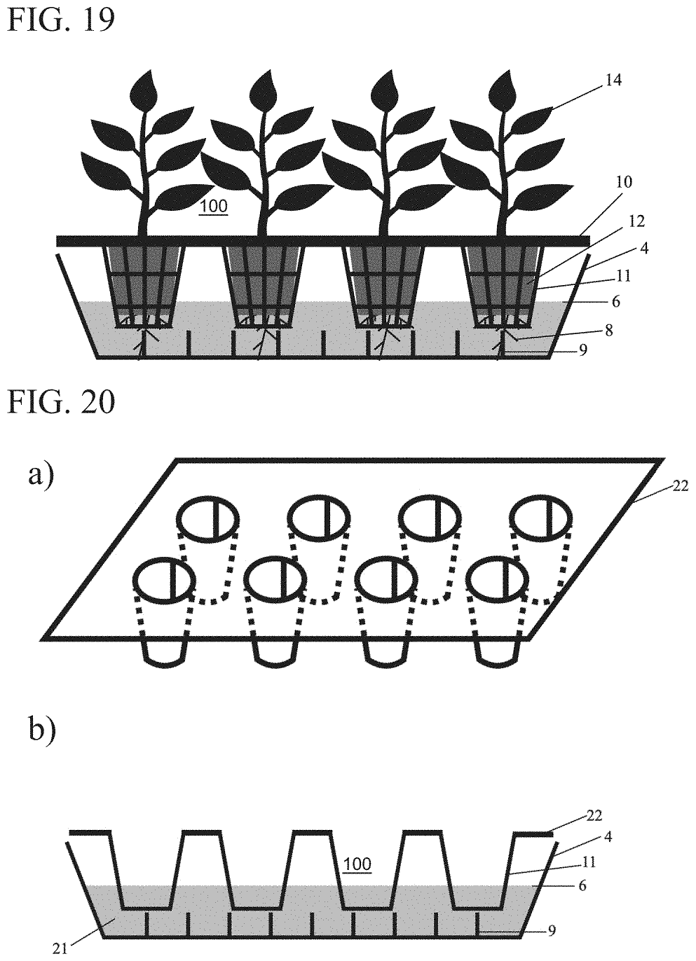

FIG. 19 includes a cross-sectional view of a net-cup growing system including plants, according to various embodiments of the invention. FIG. 19 shows a Cross sectional view demonstrating the net cup growing system with grow media plugs (12) with plants (14) sitting in the grow tray (4). The grow media plugs (12) provide support to the plants (14) and the net cup portion of the lid (11) holds the grow media plugs (12) and is submerged such that the grow media plugs get water which has been filled in the grow tray up to the water level (6). The plants may be grown elsewhere and transplanted into the net-cup growing system for continued growth or life support or the plants could have been grown from seed in the system.

FIG. 20 includes a) top isometric view of a component of a net-cup growing system, and b) cross-sectional view of a net-cup growing system, according to various embodiments of the invention. FIG. 20 Top isometric view of a pressed media/cup lid combination (23) and b) cross sectional view demonstrating use of a pressed media/cup lid combination (23). The pressed media/cup lid combination could be formed in a similar process to stamping, where sheet of material such as semi-absorbent sheet (7) is pressed to impose cups and a lid such that this single piece can be placed in a grow tray (4) and accommodate grow media plugs (12). A separate lid-net cup version (10) might not even be needed, nor would a semi-absorbent sheet (7) in some embodiments of the invention, because the pressed media/cup lid combination (23) would itself serve as the growing substrate and provide that structure.

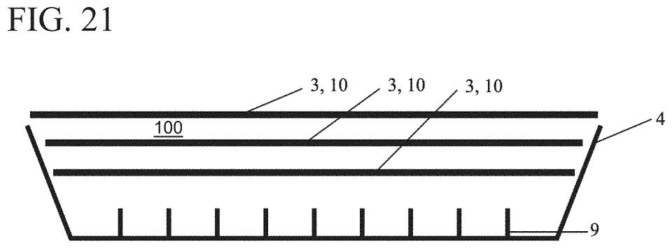

FIG. 21 includes a cross-sectional view of a bulb or net-cup growing system having multiple lids of various sizes, according to various embodiments of the invention. This system is optionally provided in the form of a kit configured to grow bulbs of different sizes. FIG. 21 shows a cross sectional view demonstrating another way to adjust the height of the tray lid (3). By varying the dimensions of the lid, it can be configured to sit either higher or lower in a grow tray (4). In a circular grow tray (4) for example, a smaller diameter lid would sit lower while a larger diameter lid would sit higher. Some embodiments include a kit comprising multiple tray lids (3) having different dimensions, spacers (16) of different heights, tray lids (3) of different shapes, and/or the like.

References to a net cup or net cup portion of the lid, may include any of the slotted hydroponic cups, used in industry, that allow roots to grow out and water to get to the peat, coconut coir, rock wool or other media plug in the cup.

In the removable cup design pictured in FIG. 16, the cups are optionally made of different plastics, metal, silicone, or compostable or natural materials including but not limited to coconut fiber, wood, bamboo, straw, twine or other rope, hemp, jute etc.

The various embodiments described herein can be applied to the bulb and net cup growing systems for bulbs or vegetable plants respectively, the growing system is not limited to these organisms. Organisms including but not limited to fungi, non-edible plants, ornamental bulbs, flowers etc. could also be grown in either system depending on the specific organism's needs.

While the disclosed embodiments may be designed and implemented systems for growing microgreens, and/or for other plants including but not limited to green onions, garlic, celery, fennel, etc.

While the disclosure describes versions of the bulb growing system and net cup growing systems where the tray is made taller or the lid is made taller or shorter to accommodate different sized plants, other components of the tray including the riser height, fill line, or even net cup depth, hole density, grow plug composition could all be tailored to provide optimal growing conditions for the plant. Additional IP could be focused on those specific parameters to optimize growth.

As illustrated in FIG. 20, instead of net cups, there could also just be a pressed/formed semi-absorbent sheet inserted into the grow tray below the lid that has the cups pre-pressed into them. Then you just put the lid over it and insert the plant directly into the semi-absorbent layer through the lid. The tray lid may be optional.

For the convex and concave lids of FIG. 3 (a and b) the height of the semi-absorbent sheet, height of the water, or both could be adjusted to further accommodate the differently sized bulbs. For example in the concave version of FIG. 3 (b), a thinner semi-absorbent sheet and lower water level could suffice for a smaller bulb, while in a convex version of FIG. 3 (a), a thicker semi-absorbent sheet and higher water level could work because the bulb is larger and may need more water/structure.

For the “topographic” lid design of FIG. 4 or any other lid design could be 3D printed, molded, CNCd, or otherwise shaped to appear as a relief of a real location. For example, taking the topographic map of a mountainous area or cityscape, and 3D printing a lid that has the relief in miniature.

Though the tray lids shown in the various figures are pictured as angular in nature does not preclude them from being rounded, curved or contoured or a combination.

Several embodiments are specifically illustrated and/or described herein. However, it will be appreciated that modifications and variations are covered by the above teachings and within the scope of the appended claims without departing from the spirit and intended scope thereof. For example, while the examples disclosed herein are directed primarily at an enclosed growing tray. In alternative embodiments the improvements taught can be applied to a flowthrough system in which a flow of water travels through an extended tray or trough. Such systems can include pumps, automated harvesting, light sources, and/or other standard elements of hydroponic or aquaponic systems. For example, fish or other beneficial organisms may be added to trays or other containers with an aquaponic system. In some embodiments, the systems disclosed herein are configured to be used as a fish tank lid, optionally allowing roots (8) to enter water of the fish tank. Embodiments of tray lid (3) optionally include lights, e.g., waterproof LED lights. Further, while the examples provided herein are directed primarily at “bulbs” the improvements taught can be applied to other plants or fungi, which can be regrown after having an upper part cut away, such as green onions, garlic or leeks.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

We claim:

1. A bulb growing system comprising:
a semi-absorbent sheet having upper and lower sides separated by a thickness;
a tray including one or more risers, the tray being configured to hold water, the risers being configured to support the semi-absorbent sheet and create a water reservoir below the semi-absorbent sheet; and
a tray lid including a plurality of openings, sides of the tray being configured to support the tray lid such that a plurality of bulbs fit between the semi-absorbent sheet and the openings, wherein the openings are configured to hold the bulbs upright within an enclosure formed by the tray and tray lid.

2. The system of claim 1, wherein the tray lid is configured to reduce water evaporation from within the tray or light reaching the bulb.

3. The system of claim 1, wherein edges of the tray or tray lid are tapered such that tray lids of different dimensions rest at different heights in the tray.

4. The system of claim 1, wherein the semi-absorbent sheet includes coconut husk.

5. The system of claim 1, further comprising a spacer configured to hold the tray lid above the tray.

6. The system of claim 1, further comprising a pump configured to flow water through the tray.

7. A bulb growing kit comprising:
a semi-absorbent sheet having upper and lower sides separated by a thickness, each of the sheets having a different thickness;
a tray including one or more risers, the tray being configured to hold water, the risers being configured to support the semi-absorbent sheet and to create a water reservoir below the semi-absorbent sheet;
a first tray lid including a plurality of openings, sides of the tray being configured to support the tray lid such that a plurality of bulbs fit between the semi-absorbent sheet and the openings, wherein the openings are configured to hold the bulbs upright within an enclosure formed by the tray and the first tray lid; and
means for controlling a height of the openings above the semi-absorbent sheets, the means including tray lids of different shapes, semi-absorbent sheets of different thicknesses, a spacer configured to be disposed between the tray and the tray lid, a tapered edge of the tray or tray lid, or a width of the tray lid.

8. The kit of claim 7, further comprising a second tray lid having openings of different size relative to the openings of the first tray lid.

9. The kit of claim 7, wherein the thicknesses of the semi-absorbent sheets are configured to fit bulbs of different sizes between the tray and the tray lid.

10. The kit of claim 7, further comprising a second tray lid having dimensions relative to the the first tray lid.
